(19) United States
(12) Patent Application Publication
(10) Pub. No.: US 2012/0095811 A1
(43) Pub. Date: Apr. 19, 2012

(54) ELECTRONIC VOTING SYSTEM

(76) Inventor: Kozo Tagawa, Kanagawa (JP)

(21) Appl. No.: 13/378,870

(22) PCT Filed: Oct. 19, 2010
(86) PCT No.: PCT/JP2010/068793

§ 371 Date: Dec. 16, 2011

(30) Foreign Application Priority Data
Dec. 22, 2009 (JP) 2009-291006

(51) Int. Cl. G07C 13/02

(52) U.S. Cl. 705/12

(57) ABSTRACT

Disclosed is an electronic voting system in which a polling administration unit, upon receiving encoded vote content data encoded by a temporary key from a voting unit, generates a reference value capable of identifying sameness of the encoded vote content data and sends it to a voter list administration unit, the voter list administration unit receives the temporary key, the reference value of the encoded vote content data, and voter identification data for identifying a voter from the voting unit, determines that a vote is valid when the reference value received from the voting unit and the reference value received from the polling administration unit match as well as a voter identified by the voter identification data is qualified by voter list data.

### TECHNICAL FIELD

The present invention relates to a technique for constructing and controlling an electronic voting system usable for an election or a questionnaire.

### BACKGROUND ART

With the diffusion of personal computers (PCs), Internet, mobile phones and the like, an environment where a large number of people can easily handle data processing terminals has been reached and performing electronic voting or electronic questionnaires may be actualized.

Although there have been various electronic voting systems proposed (see patent document 1, for example), those systems are weighted on efficiency as data processing systems and many of them have an embodiment where an integrally structured processing system processes operations by accepting vote contents from voters via networks.

### RELATED ART

### Patent Document

Patent document 1: Japanese Laid-open Patent Publication No. 2009-193544

### SUMMARY OF THE INVENTION

### Problems to be Solved by the Invention

In order to efficiently transition to electronic voting from conventional paper based voting, it is necessary to have weights on conventional distributed functions such as a voter list administration, a polling place, and a ballot-counting place, and maintain the roles corresponding to those functions on a system as well.

In such a case, conditions required for an electronic voting system may be as follows.
(1) Nobody can know the results of voting until the votes are counted.
(2) Voters are previously recorded and can vote only once.
(3) Nobody can know who voted for whom.
(4) Voters cannot show evidence regarding for whom they voted.
(5) Voters cannot show evidence regarding for whom they voted even by forced intervention.
(6) Voters can confirm whether their votes are counted.
(7) It can be confirmed that final opened results are obtained by proper counting of all of the votes.

Here, condition (1) is for guaranteeing independence and safety of the ballot-counting place. Condition (2) is for guaranteeing the qualifications of the voters. Conditions (3) to (5) are for guaranteeing anonymity of voters or prevention of voting by forced intervention. Conditions (6) and (7) are for guaranteeing confirmation of voting results.

Conventionally, an electronic voting system that fulfills such conditions well is not known and there has been a wait for one to be provided.

The present invention is made in light of the above problems, and may provide an electronic voting system with high feasibility having weights on the conventional distributed functions such as a voter list administration, a polling place, and a ballot-counting place, and capable of fulfilling in part or all of the above conditions.

### Means to Solve the Problems

In order to solve the above problems, according to the present invention, as described in claim 1, there is provided an electronic voting system including a voting unit, a voter list administration unit, a polling administration unit and a ballot-counting administration unit establishing communications with secured securities with each other, wherein the polling administration unit, upon receiving encoded vote content data encoded by a temporary key from the voting unit, generates a reference value capable of identifying sameness of the encoded vote content data and sends the reference value to the voter list administration unit, the voter list administration unit receives the temporary key, the reference value of the encoded vote content data, and voter identification data for identifying a voter from the voting unit, and determines that a vote is valid when the reference value received from the voting unit and the reference value received from the polling administration unit match as well as a voter identified by the voter identification data is qualified by voter list data to send the reference value of the encoded vote content data as a valid voting report to the polling administration unit and to further send the temporary key and the reference value to the ballot-counting administration unit, the polling administration unit sends the encoded vote content data and the reference value of the encoded vote content data to the ballot-counting administration unit at a predetermined time, and the ballot-counting administration unit decodes the encoded vote content data by the temporary key, for the temporary key and the encoded vote content data the reference values of which match among received data from the voter list administration unit and the polling administration unit, to obtain vote content data.

As described in claim 2, the electronic voting system according to claim 1, wherein when the voter list administration unit determines that the vote is valid, the voter list administration unit may obtain classified information of the voter, and may send the classified information with the reference value in correspondence with each other to the ballot-counting administration unit.

As described in claim 3, the electronic voting system according to claim 1 or 2, wherein the voter identification data may be an electronic signature by a secret key of a voter.

As described in claim 4, the electronic voting system according to any one of claims 1 to 3, wherein the voter list administration unit may determine that the vote is valid when the voter identified by the voter identification data exists in the voter list data as well as the vote is the first time.

As described in claim 5, the electronic voting system according to any one of claims 1 to 4, wherein the voter list administration unit may issue a time indicating when the vote is performed and an accumulated voting number and return those to the voting unit when the vote is determined to be valid.

As described in claim 6, the electronic voting system according to any one of claims 1 to 5, wherein the voter list administration unit may record the temporary key, and a time indicating when the vote is performed and an accumulated voting number which are issued when the vote is determined to be valid with the reference value in correspondence with each other, and the polling administration unit may record the encoded vote content data and an equation for generating the reference value.

### Effect of the Invention

According to the electronic voting system of the present invention, an electronic voting system with high feasibility can be provided by having weights on the conventional distributed functions such as a voter list administration, a polling place, and a ballot-counting place.

### BRIEF DESCRIPTION OF DRAWINGS

FIG. 1 shows an example of a structure of a system according to an embodiment;

FIG. 2 shows an example of a hardware structure of each of the apparatuses;

FIG. 3 is a sequence view (No. 1) showing an example of operations of the embodiment; and

FIG. 4 is a sequence view (No. 2) showing an example of operations of the embodiment.

### EMBODIMENT

The preferred embodiments will be explained.

### <Structure>

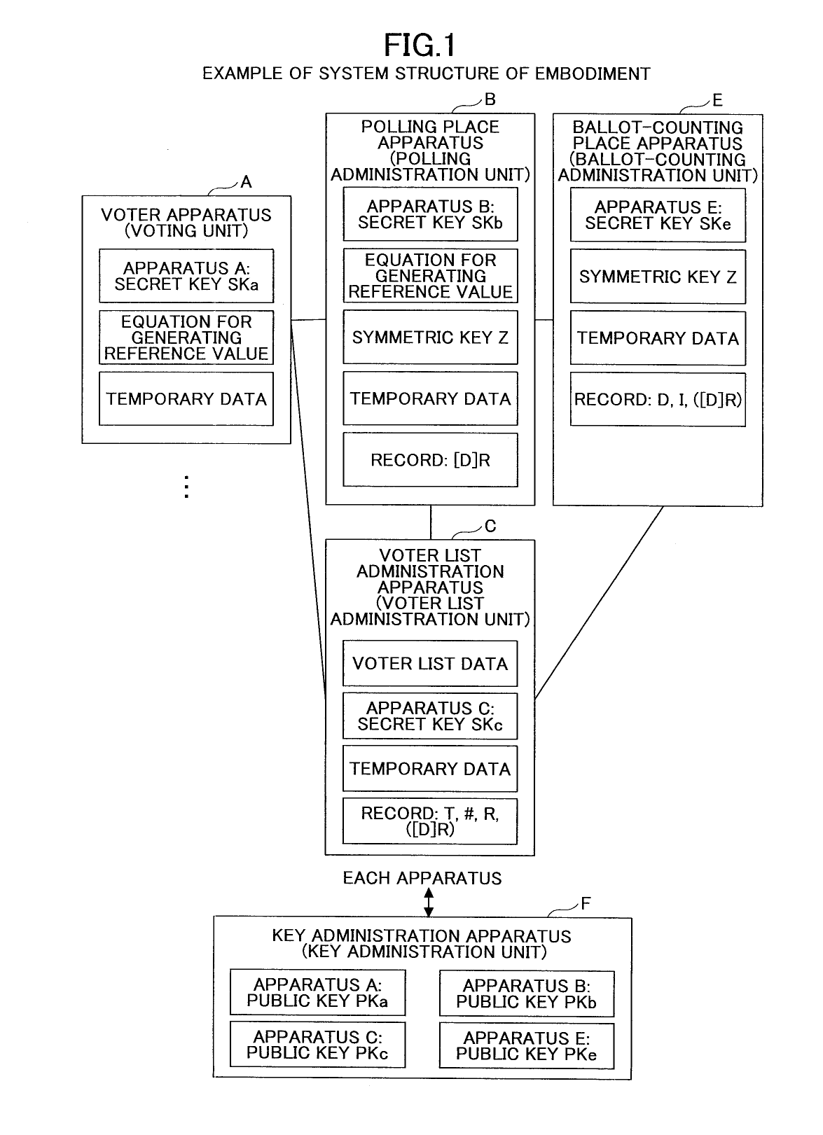

FIG. 1 shows an example of a structure of a system according to an embodiment of the present invention.

As shown in FIG. 1, the system of the embodiment includes a voter apparatus (a voting unit) A, a polling place apparatus (a polling administration unit) B, a voter list administration apparatus (a voter list administration unit) C, a ballot-counting place apparatus (a ballot-counting administration unit) E, and key administration apparatus (a key administration unit) F, connected with each other through networks.

The voter apparatus A is a data processing terminal apparatus such as a PC, a mobile phone or the like operated by a voter. The voter apparatus A may be owned by the voter, or may be positioned at a polling place or the like by the operator side of an election or the like. When the voter apparatus A is the data processing terminal apparatus owned by a voter, it is desirable to perform user identification such as performing a biometric identification, taking a photograph or the like at the voter apparatus A side so that other people cannot falsely vote.

As for the operations, a secret key SKa of the voter apparatus A, and a predetermined equation for generating a reference value such as a hash computing equation or the like for generating reference value data, which will be explained later, are used, and various temporary data, which will be explained later, exist. The secret key SKa is used for having a communication in secret as well as a signature to specify a voter. Other methods may be used for specifying the voter or having the communication in secret.

The polling place apparatus B is a data processing apparatus such as a server apparatus, a PC or the like that accepts votes from the voter apparatus A. As for the operations, a secret key SKb of the polling place apparatus B, a predetermined equation for generating a reference value such as a hash computing equation or the like for generating reference value data, and a symmetric key Z are used, and various temporary data, which will be explained later, exist. The secret key SKb and the key Z are used for having the communication in secret and when other methods are used for having the communication in secret, these are not necessary. Further, as for records of the operations, an encoded vote content data “[D]R”, which will be explained later, is recorded. Reference value data “([D]R)” may be obtained by an encoded vote content data “[D]R” and the equation for generating the reference value. The equation for generating the reference value may be separately controlled, or controlled as a record of the polling place apparatus B.

The voter list administration apparatus C is a data processing apparatus such as a server apparatus, a PC or the like that determines qualification of a voter. As for the operations, a secret key SKc of the voter list administration apparatus C in addition to voter list data are used, and various temporary data, which will be explained later, exist. The secret key SKc is used for having the communication in secret and when other methods are used for having the communication in secret, this is not necessary. Further, as for records of the operations, a time stamp T, a voting number #, a temporary key R and the reference value data “([D]R)”, which will be explained later, are recorded.

The ballot-counting place apparatus E is a data processing apparatus such as a server apparatus, a PC or the like that performs counting or opening of ballots or votes. As for the operations, a secret key SKe of the ballot-counting place apparatus E and the symmetric key Z are used, and various temporary data, which will be explained later, exist. The secret key SKe and the key Z are used for having the communication in secret and when other methods are used for having the communication in secret, these are not necessary. Further, as for records of the operations, finally obtained vote contents D, classified information I, and reference value data “([D]R)” are recorded.

The key administration apparatus F is a data processing apparatus such as a server apparatus, a PC or the like that retains public keys previously issued for the respective apparatuses in accordance with public key cryptosystems. The key administration apparatus F includes public keys PKa, PKb, PKc and PKe of the apparatuses.

The polling place apparatus B, the voter list administration apparatus C, and the ballot-counting place apparatus E may be provided at geographically remote places or may be provided at the same place. Further, those may be composed of physically different respective apparatuses or may be composed of respective components constructed by software in a single apparatus.

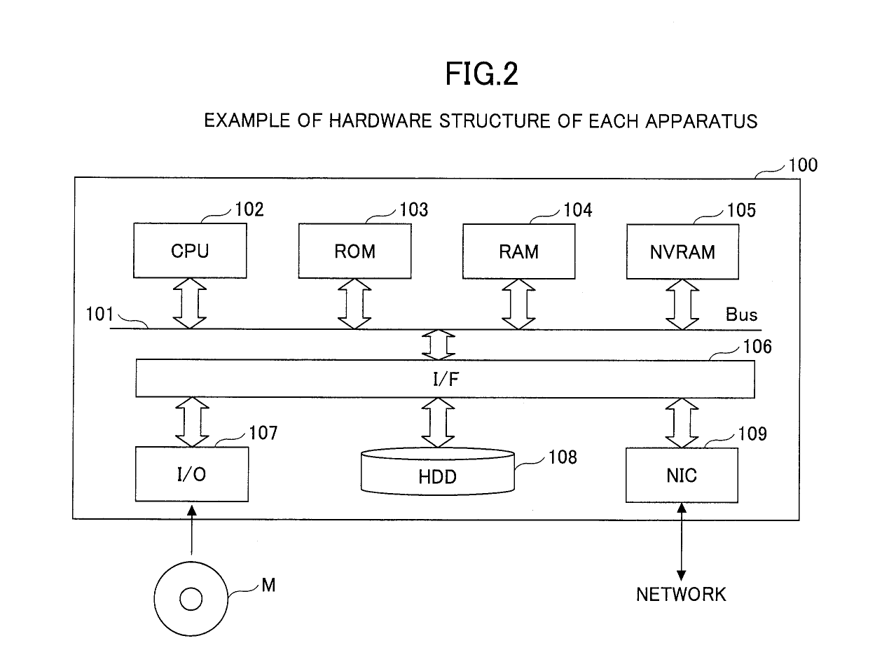

FIG. 2 shows an example of a hardware structure of each of the apparatuses.

As shown in FIG. 2, each of the apparatuses 100 includes a CPU 102, a ROM 103, a RAM 104, a NVRAM (Non-Volatile Random Access Memory) 105, and an I/F (Interface) 106 connected to a system bus 101, an I/O (Input/Output Device) 107 such as a keyboard, a mouse, a monitor, a CD/DVD (Compact Disk/Digital Versatile Disk) drive or the like, a HDD (Hard Disk Drive) 108, and a NIC (Network Interface Card) 109 connected to the I/F 106 and the like. “M” means a medium (recording medium) such as a CD/DVD or the like where a program or data is stored.

### <Operation>

The operations of the embodiment will be explained hereinafter. In the following description, “SKx” expresses a secret key of an apparatus X, “PKx” expresses a public key of an apparatus X, “(Y)” expresses a digest value of data Y, and “[Y]K” expresses encoded data of data Y encoded by a cryptographic key K. Here, the digest value means a value obtained by converting original data by a hash computing equation or the like that becomes a different value when the original data is different so that it can be used for identifying sameness of original data. Further, the digest value means a value that is very difficult to regenerate the original data therefrom.

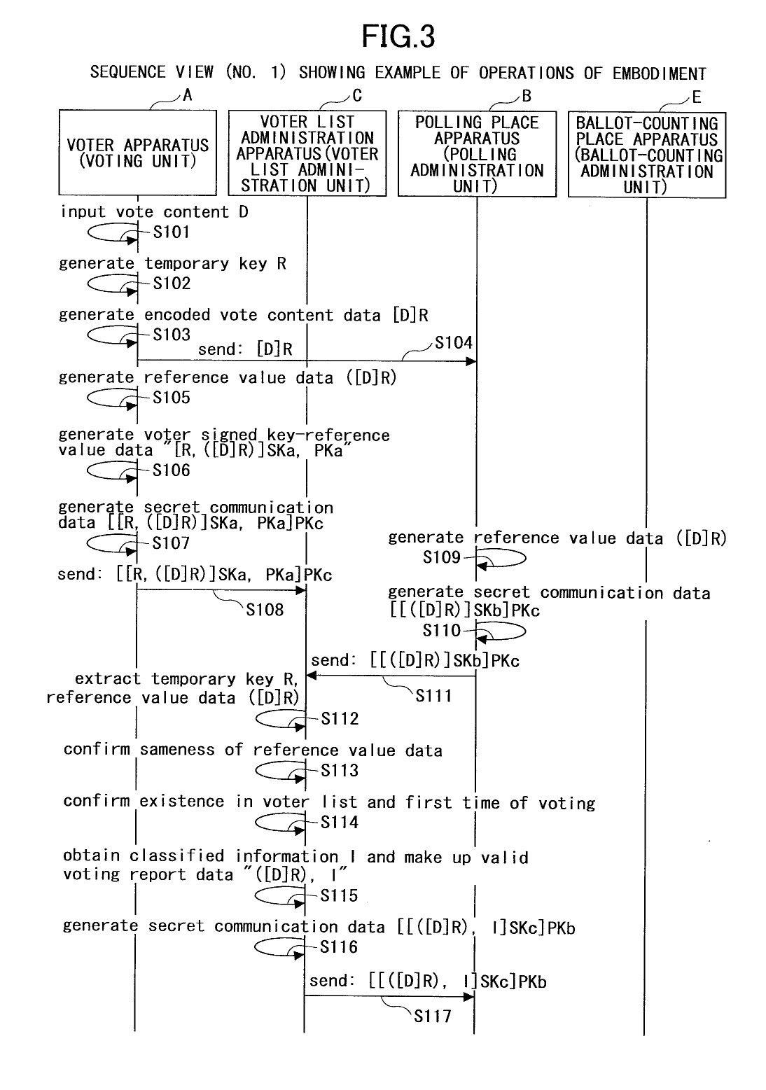

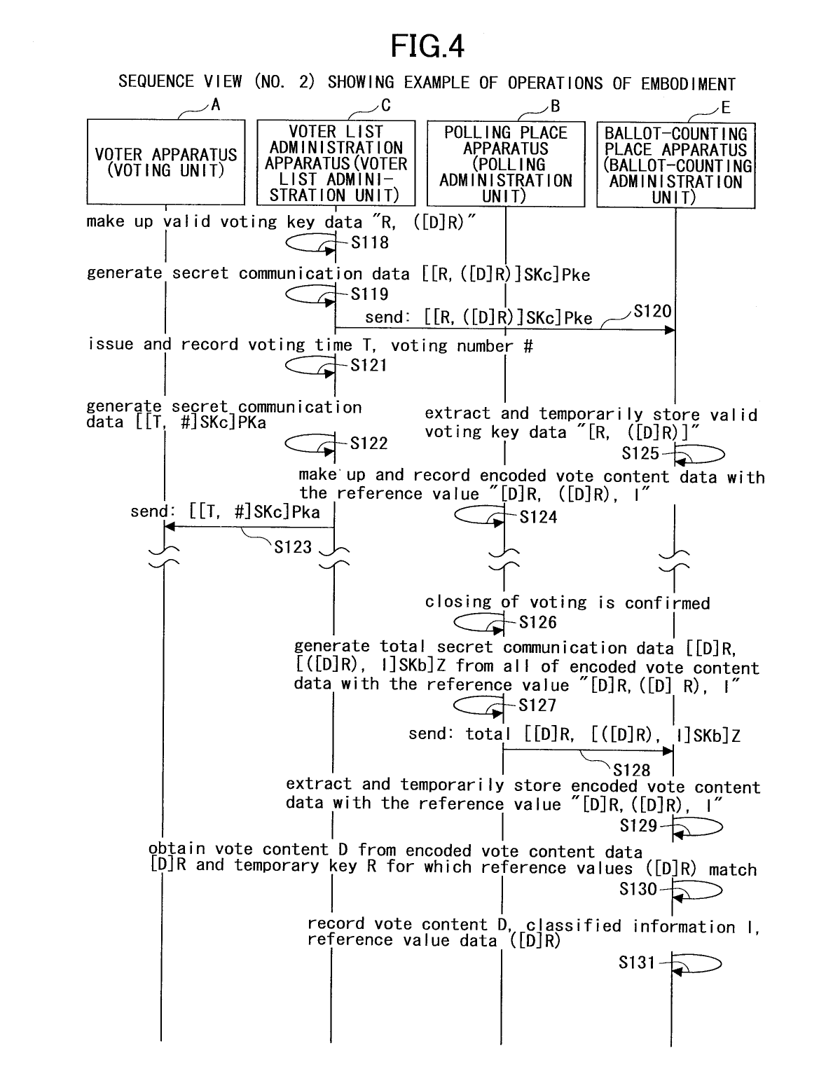

FIG. 3 and FIG. 4 are sequence views showing an example of operations of the embodiment.

In FIG. 3, when a voter operates the voter apparatus A to input a vote content D (step S101), the voter apparatus A randomly generates a temporary key R (step S102), generates encoded vote content data “[D]R” (step S103), and sends the encoded vote content data “[D]R” from the voter apparatus A to the polling place apparatus B (step S104).

Then, the voter apparatus A generates reference value data “([D]R)”, which is a digest value of the encoded vote content data “[D]R”, from the encoded vote content data “[D]R” in accordance with the predetermined equation for generating the reference value (step S105).

Then, the voter apparatus A applies an electronic signature on the previously generated temporary key R and the reference value data “([D]R)” by a secret key SKa of the voter, adds a public key PKa, and generates voter signed key-reference value data “[R, ([D]R)]SKa, PKa” (step S106). The reason why the public key PKa is included in the voter signed key-reference value data here is for performing a high-speed confirmation of the signature at the receiving side and when the public key can be specified by other methods, the public key PKa may not be included. Further, other voter identification data capable of identifying a voter may be used instead of the electronic signature by the secret key SKa of the voter.

Then, the voter apparatus A applies a public key PKc of the voter list administration apparatus C, which is the receiver, on the voter signed key-reference value data “[R, ([D]R)]SKa, PKa” to generate secret communication data “[[R, ([D]R)]SKa, PKa]PKc” (step S107), and sends it from the voter apparatus A to the voter list administration apparatus C (step S108). Here, under an environment where the voter apparatus A and the voter list administration apparatus C can have secured communication, for example they are connected via a private line or the like, the voter signed key-reference value data “[R, ([D]R)]SKa, PKa” may be sent as is. Further, instead of encoding with the public key, other secret communication methods may be used.

The polling place apparatus B, that receives the encoded vote content data “[D]R” from the voter apparatus A, generates reference value data “([D]R)” from the encoded vote content data “[D]R” in accordance with the predetermined equation for generating the reference value (step S109), generates secret communication data “[[([D]R)]SKb]PKc” by applying a secret key SKb, which is a signature of the polling place apparatus B itself, and a public key PKc of the voter list administration apparatus C, which will be a receiver (step S110), and sends it from the polling place apparatus B to the voter list administration apparatus C (step S111). Here, under an environment where the polling place apparatus B and the voter list administration apparatus C can have secured communication and in which the opposite sides of the communication can be confirmed, for example, where they are provided in a single apparatus, connected via a private line even when separately provided in different apparatuses or the like, the reference value data “([D]R)” may be sent as is. Further, instead of encoding with the secret key and the public key, other secret communication methods may be used.

The voter list administration apparatus C, after receiving data from the voter apparatus A and the polling place apparatus B, extracts values included in both of the data (step S112). The voter list administration apparatus C decodes the secret communication data “[[R, ([D]R)]SKa, PKa]PKc” received from the voter apparatus A by applying its secret key SKc to obtain data “[R, ([D]R)]SKa, PKa”, and further decodes it by applying the public key PKa of the voter apparatus A to obtain the temporary key R and the reference value data “([D]R)”. The voter list administration apparatus C also decodes the secret communication data “[[([D]R)]SKb]PKc” received from the polling place apparatus B by applying its secret key SKc to obtain data “[([D]R)]SKb”, and further decodes it by applying the public key PKb of the polling place apparatus B to obtain the reference value data “([D]R)”.

The voter list administration apparatus C then compares the reference value data “([D]R)” obtained from the data via the voter apparatus A and the reference value data “([D]R)” obtained from the data via the polling place apparatus B to determine their sameness (step S113).

The voter list administration apparatus C refers to voter list data based on the voter identification data such as the decoded public key PKa or the like of the data for which the sameness is confirmed and also confirms whether the voter identification data exists in the voter list as well as when it is a first time of voting (step S114). Whether it is the first time of voting may be determined by recording votes in connection with the voter list data, and determines it is the first time of voting for a new vote that is not recorded as already voted. Alternatively, the voter identification data, for the voter for whom the determination is done, may be recorded separately from the voter list data and determines it is the first time of voting when a public key of a new voter is not included in the separated record.

When it is confirmed that the voter identification data exists in the voter list and it is the first time of voting, the voter list administration apparatus C obtains classified information I such as sex, age, assigned region or the like from the voter list data, makes up valid voting report data including reference value data “([D]R), I” including the classified information I as content (step S115), applies the secret key SKc, which is the signature of the voter list administration apparatus C, and the public key PKb of the polling place apparatus B, which will be the receiver, to generate secret communication data “[[([D]R), I]SKc]PKb” (step S116), and sends it from the voter list administration apparatus C to the polling place apparatus B (step S117). Here, under an environment where the voter list administration apparatus C and the polling place apparatus B can have secured communication and in which the opposite sides of the communication can be confirmed, for example, where they are provided in a single apparatus, connected via a private line even when separately provided in different apparatuses or the like, the valid voting report data “([D]R)” may be sent as is. Further, instead of encoding with the secret key and the public key, other secret communication methods may be used.

Subsequently, as shown in FIG. 4, the voter list administration apparatus C makes up valid voting key data “R, ([D]R)” based on the previously obtained data (step S118), applies the secret key SKc, which is the signature of the voter list administration apparatus C, and the public key PKe of the ballot-counting place apparatus E, which will be the receiver, to generate secret communication data “[[R,([D]R)]SKc]PKe” (step S119), and sends it from the voter list administration apparatus C to the ballot-counting place apparatus E (step S120). Here, under an environment where the voter list administration apparatus C and the ballot-counting place apparatus E can have secured communication and in which the opposite sides of the communication can be confirmed, for example, where they are provided in a single apparatus, connected via a private line even when separately provided in different apparatuses or the like, the valid voting key data “R, ([D]R)” may be sent as is. Further, instead of encoding with the secret key and the public key, other secret communication methods may be used.

Subsequently, the voter list administration apparatus C issues a time stamp T based on a current time (controlled by the operating system of the computer composing the voter list administration apparatus C) and a new voting number # based on the proximate voting number #, which is the accumulated voting number, and records them with the temporary key R and the reference value data “([D]R)” in correspondence with each other (step S121). These records are not corresponding with the voter list data.

Then, the voter list administration apparatus C applies the secret key SKc, which is the signature of the voter list administration apparatus C, and the public key PKa of the voter apparatus A (voter), which will be the receiver, on the time stamp T and the voting number # to generate secret communication data “[[T, #]SKc]PKa” (step S122), and sends it from the voter list administration apparatus C to the voter apparatus A (step S123). Here, under an environment where the voter list administration apparatus C and the voter apparatus A can have secured communication, for example, where they are connected via a private line or the like, the time stamp T and the voting number # may be sent as is. Further, instead of encoding with the secret key and the public key, other secret communication methods may be used.

The polling place apparatus B makes up encoded vote content data with the reference value “[D]R, ([D]R), I” based on the previously obtained data and records the encoded vote content data [D]R (step S124). The polling place apparatus B temporarily stores the whole encoded vote content data with the reference value “[D]R, ([D]R), I” for future operations.

The ballot-counting place apparatus E extracts the temporary key R and the reference value data “([D]R)” from the secret communication data “[[R, ([D]R)]SKc]PKe” received from the voter list administration apparatus C and temporarily stores them (step S125). It means that the ballot-counting place apparatus E decodes the secret communication data “[[R, ([D]R)]SKc]PKe” by applying its secret key SKe, then further decodes the decoded data by applying the public key PKc of the voter list administration apparatus C to obtain the valid voting key data “R,([D]R)”, and then records it.

The above operations are repeatedly performed every time a vote is sent from different voter apparatuses A. When a vote is sent from the same voter apparatus A, it is determined as not being the first time of voting with confirmation by the voter list data (step S114), and treated as an invalid vote so that no further operations are performed.

Subsequently, when the polling place apparatus B confirms a close of voting at a predetermined time or by an indication from an operator (step S126), the polling place apparatus B generates secret communication data “[[D]R, [([D]R), I]SKb]Z” by applying the secret key SKb, which is the signature of the polling place apparatus B, and the symmetric cryptographic key Z, which was previously set between the polling place apparatus B and the ballot-counting place apparatus E, on the temporarily stored encoded vote content data with the reference value “[D]R,([D]R), I” corresponding to all of the votes (step S127), and sends it from the polling place apparatus B to the ballot-counting place apparatus E (step S128). Here, under an environment where the polling place apparatus B and the ballot-counting place apparatus E can have secured communication and in which the opposite sides of the communication can be confirmed, for example, where they are provided in a single apparatus, connected via a private line even when separately provided in different apparatuses or the like, the encoded vote content data with the reference value “[D]R,([D]R), I” may be sent as is. Further, instead of encoding with the secret key and the public key, other secret communication methods may be used.

After receiving the secret communication data “[[D]R, [([D]R), I]SKb]Z” from the polling place apparatus B, the ballot-counting place apparatus E decodes the data by applying the symmetric cryptographic key Z to obtain “[D]R, [([D]R), I]SKb”, further decodes it by applying the public key PKc of the voter list administration apparatus C to obtain the encoded vote content data with the reference value “[D]R,([D]R), I”, and temporarily stores it (step S129).

Then, the ballot-counting place apparatus E compares the reference value data “([D]R)” included in the temporarily stored valid voting key data “R,([D]R)”, obtained via the voter list administration apparatus C, and the temporarily stored encoded vote content data with the reference value “[D]R,([D]R), I”, obtained via the polling place apparatus B, and decodes the encoded vote content data “[D]R” by the temporary key R for which the reference values match to obtain the vote contents D (step S130). Then, the ballot-counting place apparatus E records the decoded vote contents D, the classified information I, and the reference value data “([D]R)” (step S131).

The ballot-counting place apparatus E finishes the operation of ballot-counting when the operations for all of the valid voting key data “R, ([D]R)” and the encoded vote content data with the reference value “[D]R,([D]R), I” are finished.

The temporarily stored data, other than data recorded for later verification, are deleted in the respective apparatuses.

### ALTERED EXAMPLES

In the above embodiment, the polling place apparatus B sends the encoded vote content data with the reference value“[D]R,([D]R)” corresponding to all votes to the ballot-counting place apparatus E after the close of voting is confirmed (step S128 of FIG. 4). However, as for a case like a questionnaire where counting of votes promotes subsequent votes, the polling place apparatus B may successively send the encoded vote content data with the reference value “[D]R,([D]R)” to the ballot-counting place apparatus E.

Further in the above embodiment, the voter list administration apparatus C sends the data including the classified information I such as sex, age, assigned region or the like to the ballot-counting place apparatus E via the polling place apparatus B (step S117 of FIG. 3 or step S128 of FIG. 4), the classified information I may be included in the data with the valid voting key data sent from the voter list administration apparatus C to the ballot-counting place apparatus E (step S120 of FIG. 4). With this, aggregation of the classified information can be possible without individually identifying the voters.

Further in the above embodiment, although only the operations of electric voting are described, the operation of the embodiment may be performed with conventional handwritten voting. In such a case, voters perform the handwritten voting at physically settled polling places. The results of the handwritten voting are aggregated with the results of the electronic voting.

### <As a Whole>

As described above, according to the present embodiment, the following merits can be obtained.
(1) Nobody can know the vote contents D until both the valid voting key data “R, ([D]R)”, which are output from the voter list administration apparatus C every time a vote is performed, and the encoded vote content data with the reference value “[D]R,([D]R)”, which are output from the polling place apparatus B at a predetermined time such as the close of voting or the like are obtained, and after counting of votes starts, the vote contents D can only be obtained at the ballot-counting place apparatus E, therefore, the independence and safety of the counting place can be guaranteed.
(2) As the voter list administration apparatus C determines that a vote is valid when the voter is confirmed to be qualified by the voter list data (concretely, the voter is determined to be qualified when the voter exists in the voter list data, as well as the vote is the first time), the qualifications of voters can be guaranteed.
(3) As the vote contents D and the voters do not correspond with each other when opening the votes at the ballot-counting place apparatus E and corresponding data for them do not exist at any other places, anonymity of voters and prevention of forced intervention can be guaranteed.
(4) As the vote contents D can be obtained later from the temporary key R, the time stamp T, the voting number #, and the reference value data “([D]R)” recorded in the voter list administration apparatus C, and the encoded vote content data “[D]R” and the predetermined equation for generating the reference value recorded in the polling place apparatus B, properly counting of all the finally opened results obtained can be confirmed.
(5) The voter can confirm that their vote is counted by receiving the voting number and the time stamp issued by the voter list administration apparatus C when it determines the vote is valid.
(6) Nobody can know the vote contents until the vote contents are opened and after the vote contents are opened, and as the voter obtains only the voting number and the time stamp, the voter cannot show evidence regarding for whom the voter voted even by forced intervention.
(7) As a whole, an electronic voting system with high feasibility, having weights on the conventional distributed functions such as a voter list administration, a polling place, and a ballot-counting place, and capable of fulfilling conditions necessary for the electronic voting system can be provided.

As described above, the present invention is described with preferred embodiments thereof. Although the present invention is described with specific examples, the present invention is not limited to the specifically disclosed embodiments, and variations and modifications may be made without departing from the scope of the present invention. The present invention is not limited to the embodiments illustrated for explanatory purposes.

### Description of Marks and Numerals

A voter apparatus

B polling place apparatus

C voter list administration apparatus

E ballot-counting place apparatus

F key administration apparatus

1. An electronic voting system comprising a voting unit, a voter list administration unit, a polling administration unit and a ballot-counting administration unit establishing communications with secured securities with each other, wherein
the polling administration unit, upon receiving encoded vote content data encoded by a temporary key from the voting unit, generates a reference value capable of identifying sameness of the encoded vote content data and sends the reference value to the voter list administration unit,
the voter list administration unit receives the temporary key, the reference value of the encoded vote content data, and voter identification data for identifying a voter from the voting unit, and determines that a vote is valid when the reference value received from the voting unit and the reference value received from the polling administration unit match as well as a voter identified by the voter identification data is qualified by voter list data to send the temporary key and the reference value to the ballot-counting administration unit,
the polling administration unit sends the encoded vote content data and the reference value of the encoded vote content data to the ballot-counting administration unit at a predetermined time, and
the ballot-counting administration unit decodes the encoded vote content data by the temporary key, for the temporary key and the encoded vote content data the reference values of which match among received data from the voter list administration unit and the polling administration unit, to obtain vote content data.

2. The electronic voting system according to claim 1, wherein when the voter list administration unit determines that the vote is valid, the voter list administration unit obtains classified information of the voter, and sends the classified information with the reference value in correspondence with each other to the ballot-counting administration unit.

3. The electronic voting system according to claim 1, wherein the voter identification data is an electronic signature by a secret key of a voter.

4. The electronic voting system according to claim 1, wherein the voter list administration unit determines that the vote is valid when the voter identified by the voter identification data exists in the voter list data as well as the vote is the first time.

5. The electronic voting system according to claim 1, wherein the voter list administration unit issues a time indicating when the vote is performed and an accumulated voting number and returns those to the voting unit when the vote is determined to be valid.

6. The electronic voting system according to claim 1, wherein the voter list administration unit records the temporary key, and a time indicating when the vote is performed and an accumulated voting number which are issued when the vote is determined to be valid with the reference value in correspondence with each other, and the polling administration unit records the encoded vote content data and an equation for generating the reference value.

7. The electronic voting system according to claim 1, wherein when the voter list administration unit determines that the vote is valid, the voter list administration unit sends the reference value of the encoded vote content data as a valid voting report to the polling administration unit.
